(19) United States
(12) Patent Application Publication
(10) Pub. No.: US 2003/0017751 A1
(43) Pub. Date: Jan. 23, 2003

(54) Quick connect/disconnect terminal block

(76) Inventors: Robert J. Bennett, Lewisville, TX (US); Richard D. Morris, Ft. Worth, TX (US); Brian L. Taylor, Melbourne, FL (US)

Correspondence Address: CORNING CABLE SYSTEMS LLC, P O BOX 489, HICKORY, NC, 28603, US

(21) Appl. No.: 09/909,063

(22) Filed: Jul. 19, 2001

(51) Int. Cl. H01R 9/22

(52) U.S. Cl. 439/721

(57) ABSTRACT

A terminal block for mounting on a distribution frame in a telecommunications network includes a base defining a generally planar front surface and a generally planar rear surface opposite the front surface. A plurality of pairs of conductive terminals extend outwardly from the front and/or the rear surfaces of the base. An opening formed in the base is disposed between each pair of terminals. A dielectric plug is positioned and retained within the opening for reciprocal movement between a first position wherein the pair of terminals are electrically disconnected and a second position wherein the pair of terminals are electrically connected. The terminal block provides a quick connect/disconnect capability in the cross-connect field, thereby increasing the capacity of the terminal block, while substantially reducing or eliminating the possibility that connections on the terminal block will be inadvertently disconnected.

### BACKGROUND OF THE INVENTION

1. Field of the Invention

The present invention relates to a terminal block for mounting on a distribution frame in a telecommunications network. More specifically, the invention relates to a terminal block that provides a quick connect/disconnect capability in the cross-connect field, thereby increasing the capacity of the terminal block, while substantially reducing or eliminating the possibility that connections on the terminal block will be inadvertently disconnected.

2. Background of the Invention

Terminal blocks are used in telecommunications networks for wire management and to accomplish cross-connect and switch termination functions. Terminal blocks are typically mounted on a distribution frame in a location that is readily accessible to telephone company technicians, such as at a central office or a field office of a telephone company. With the rapid advent of DSL deployment, existing space on distribution frames and terminal blocks is being exhausted at an alarming rate. At the same time, the increase in the occurrence of “adds, deletes and changes” requires that telephone wire pairs be brought to a position on the front of the distribution frame that will enable a technician to quickly isolate, or disconnect, a particular telephone line to test the line between various signal conditioning equipment. When positioned on the front of the distribution frame, however, the connections on the terminal blocks are susceptible to being inadvertently disconnected by a technician.

A known terminal block available from the Cook Electric division of Corning Cable Systems LLC and sold under the trade name Series 130-1001 includes a cross-connect field for wiring terminations and a separate connect/disconnect field for connecting and disconnecting telephone lines on the front of the distribution frame. Because the connect/disconnect field is separate from the cross-connect field, twice as many connections are required and the number of available telephone lines is limited to about sixty twisted pairs. Accordingly, the terminal block is more costly to manufacture and configure, and there is an increased potential for connection errors and subsequent failures. Furthermore, a disconnect is accomplished by introducing a dielectric insert between the terminals to interrupt the electrical connection. Because the insert is not an integral part of the terminal block, it is readily separated from the terminal block and may become misplaced or lost.

As a result of the increased demands and the shortcomings of existing terminal blocks, a need exists for a terminal block that enables a technician to quickly connect or disconnect a particular telephone line. At the same time, a need exists for a terminal block that substantially reduces or eliminates the possibility that connections on the terminal block will be inadvertently disconnected. Still further, a need exists for a telecommunications terminal block that maintains or increases the capacity of existing terminal blocks, thereby reducing the cost to manufacture and configure the terminal block and reducing the potential for connection errors and subsequent failures. Still further, there is a need for a quick connect/disconnect terminal block that does not utilize a separate insert to interrupt the electrical connection between the terminals.

### SUMMARY OF THE INVENTION

The invention is a terminal block of the type typically mounted on a distribution frame used in a telecommunications network. In one embodiment, the terminal block includes a base and at least one pair of conductive terminals depending outwardly from the base. The base preferably defines a front surface and a rear surface separated from and opposite the front surface. One of the pair of terminals preferably depends outwardly from the front surface and one of the pair of terminals preferably depends outwardly from the rear surface. At least one opening is formed in the base and disposed between the pair of terminals. The terminal block further includes a plug positioned within the opening formed in the base for reciprocal movement between a first position wherein the pair of terminals are electrically disconnected and a second position wherein the pair of terminals are electrically connected. The plug is made of a dielectric material and includes a body and a conductive contact attached to the body that engages the pair of terminals in the second position to electrically connect the pair of terminals.

In an exemplary embodiment, the body of the plug preferably has a forward end that is inserted into the opening formed in the base and the conductive contact comprises a leaf spring attached to the forward end of the body. In another exemplary embodiment, the body of the plug preferably has a forward end that is inserted into the opening formed in the base and the conductive contact comprises a sleeve attached to the forward end of the body. In yet another exemplary embodiment, the body of the plug preferably has a forward end that is inserted into the opening formed in the base and defines a recess that receives the pair of terminals therein. The recess defined by the forward end of the plug forces the pair of terminals together in the second position to electrically connect the pair of terminals.

The plug is retained within the opening formed in the base of the terminal block in both the first position and the second position. In an exemplary embodiment, the body of the plug has an indentation and each of the pair of terminals of the terminal block has a first detent for retaining the plug in the first position. In another exemplary embodiment, the body of the plug has an indentation and each of the pair of terminals of the terminal block has a second detent for retaining the plug in the second position. In yet another exemplary embodiment, the body of the plug has an indentation and each of the pair of terminals of the terminal block has both a first detent for retaining the plug in the first position and a second detent for retaining the plug in the second position.

In another embodiment, the invention is a terminal block of the type typically mounted on a distribution frame used in a telecommunications network that includes a base and at least one pair of conductive terminals depending outwardly from the base. The base preferably defines a front surface and a rear surface separated from and opposite the front surface. One of the pair of terminals preferably depends outwardly from the front surface and one of the pair of terminals preferably depends outwardly from the rear surface. At least one opening is formed in the base and disposed between the pair of terminals. The terminal block further includes a plug made of a dielectric material and positioned within the opening formed in the base such that the pair of terminals are electrically connected when the plug is inserted into the opening. In an exemplary embodiment, the plug includes a body and a conductive contact attached to the body that engages the pair of terminals when the plug is inserted into the opening.

In another embodiment, the invention is a terminal block for mounting on a distribution frame in a telecommunications network that includes a base having a length dimension, a width dimension and a depth dimension. The depth dimension is less than the length dimension and the width dimension. The base defines a generally planar front surface and a generally planar rear surface opposite the front surface. The front surface and the rear surface are separated by the depth dimension. The terminal block further includes at least one pair of conductive wire wrap terminals depending outwardly from the base and at least one opening formed in the base and disposed between the pair of wire wrap terminals. Preferably, one of the pair of wire wrap terminals depends outwardly from the front surface of the base and one of the pair of wire wrap terminals depends outwardly from the rear surface of the base. The terminal block further includes a plug made of a dielectric material and positioned within the opening formed in the base for reciprocal movement between a disconnect position wherein the pair of wire wrap terminals are electrically disconnected and a connect position wherein the pair of wire wrap terminals are electrically connected.

In another embodiment, the invention is a distribution frame for interconnecting telephone lines in a telecommunications network. The distribution frame includes at least one terminal block mounted on the frame. The terminal block includes a base and at least one pair of conductive terminals depending outwardly from the base. At least one opening is formed in the base and disposed between the pair of terminals. The terminal block further includes a plug mounted within the opening formed in the base for reciprocal movement between a first position wherein the pair of terminals are electrically disconnected and a second position wherein the pair of terminals are electrically connected. In an exemplary embodiment, the plug is made of a dielectric material and includes a body and a conductive contact attached to the body that engages the pair of terminals in the second position to electrically connect the pair of terminals.

### BRIEF DESCRIPTION OF THE DRAWINGS

The accompanying drawings, which are incorporated in and constitute a part of this specification, illustrate one or more embodiments of the invention described more fully below and together with the following detailed description, serve to further explain the invention. In the drawings:

FIG. 1 is an elevation view of a terminal block constructed in accordance with the invention shown mounted on a portion of a distribution frame of the type typically located in a telecommunications network at a central office or a field office of a telephone company and rotated to the opened position;

FIG. 2 is an elevation view of the terminal block of FIG. 1 removed from the distribution frame and in the closed position;

FIG. 3 is a vertical sectional view of the terminal block of FIG. 2 taken along the line 3-3 and enlarged for purposes of clarity;

FIG. 4 is a horizontal sectional view of a portion of the terminal block of FIG. 2 taken along the line 4-4 and enlarged for purposes of clarity;

FIG. 5 is a vertical sectional view of an exemplary embodiment of one of the plugs of the terminal block of FIG. 1 shown in the disconnected position and enlarged for purposes of clarity;

FIG. 6 is a vertical sectional view of the plug of FIG. 5 shown in the connected position and enlarged for purposes of clarity;

FIG. 7 is a vertical sectional view of an alternative embodiment of one of the plugs of the terminal block of FIG. 1 shown in the disconnected position and enlarged for purposes of clarity;

FIG. 8 is a vertical sectional view of the plug of FIG. 7 shown in the connected position and enlarged for purposes of clarity;

FIG. 9 is a vertical sectional view of yet another alternative embodiment of one of the plugs of the terminal block of FIG. 1 shown in the disconnected position and enlarged for purposes of clarity; and

FIG. 10 is a vertical sectional view of the plug of FIG. 9 shown in the connected position and enlarged for purposes of clarity.

### DETAILED DESCRIPTION OF THE INVENTION

The invention is a quick connect/disconnect terminal block for mounting on a distribution frame in a telecommunications network. Distribution frames are typically located at a central office or a field office of a telephone company and the terminal blocks are utilized for wire management and to accomplish cross-connect and switch termination functions. The distribution frame is commonly referred to as a “main distribution frame” or “MDF” when located at the central office and is commonly referred to as an “intermediate distribution frame” or “IDF” when located at a field office. The terminal block of the present invention, however, is not limited to being mounted on a distribution frame and may be utilized at any point in a telecommunications network, for example in an interconnect cabinet, a pedestal, a closure, or any other type of enclosure where wire management, termination, connection, and/or distribution functions are accomplished. The terminal block described herein and illustrated in the accompanying figures is mounted to the horizontal face of a distribution frame for purposes of explanation only, and the invention is not intended to be so limited. For example, the terminal block of the present invention may be embodied in any apparatus for terminating and cross-connecting twisted pair telephone lines in which an integral quick connect/disconnect capability is desirable.

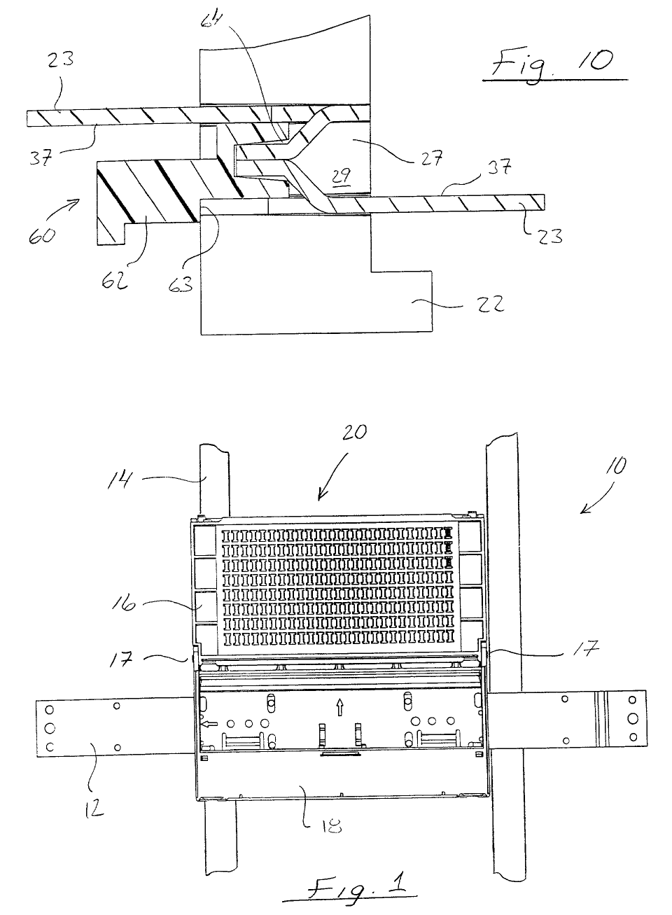

FIG. 1 shows a terminal block constructed in accordance with the invention mounted on a portion of a distribution frame, indicated generally at 10, of the type typically utilized in a telecommunications network. The terminal block, indicated generally at 20, is mounted on the distribution frame 10, such as a MDF at a central office or an IDF at a field office, in a conventional manner. The terminal block 20 may be mounted directly to a horizontal frame member 12 or a vertical frame member 14. As shown in FIG. 1, the terminal block 20 is shown in the opened position mounted within a cover 16 attached with hinges 17 to a housing 18 that is secured to a horizontal frame member 12. Accordingly, the cover 16 may be closed over the housing 18 when access to the terminal block 20 is not needed. When access to the terminal block 20 is needed, for example to accomplish cross-connect and switch termination functions, the cover 16 may be rotated about the hinges 17 from the closed position to the opened position.

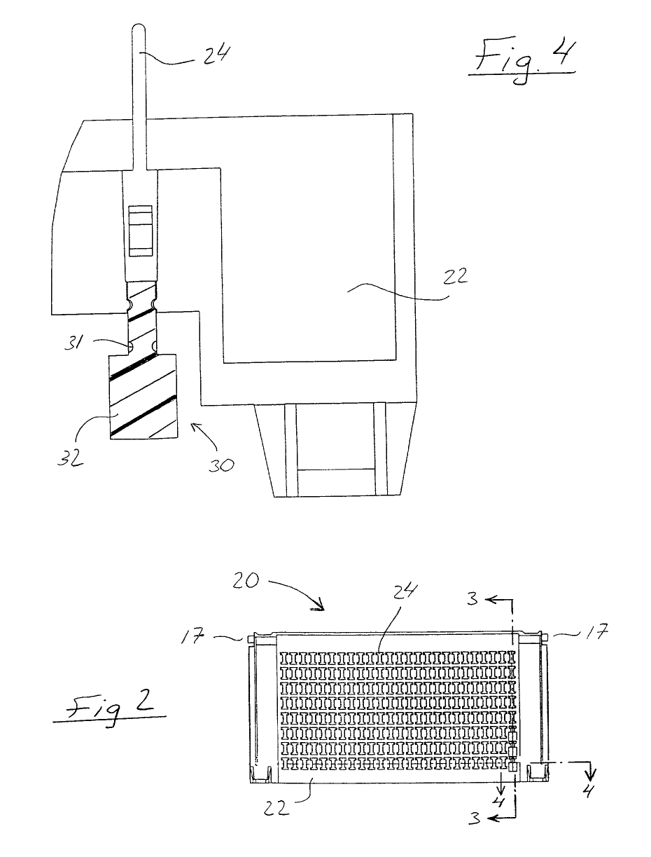

FIG. 2 shows the terminal block 20 removed from the distribution frame 10 and in the closed position. FIGS. 3 and 4 show a portion of the terminal block 20 sectioned and enlarged for purposes of clarity. In the various embodiments described and illustrated herein, the terminal block 20 comprises a base 22 and a plurality of pairs of conductive terminals 24 extending outwardly from the base. The base 22 may be made of any structural material, such as metal or plastic, that is suitable for receiving and supporting the conductive terminals 24. The conductive terminals 24 may be made of any conductive material, such as copper or gold, that is suitable for electrically connecting the tip and ring wires of twisted pair telephone lines, as will be described. The conductive terminals 24 may have any cross-sectional shape, such as square, rectangular, or circular, that permits wire terminations to be made on the ends of the terminals extending outwardly from the terminal block 20. The wire terminations may be made in any known manner, for example utilizing insulation displacement contacts (IDCs) or screw terminals, or by using a wire wrap tool to twist the free ends of the wires tightly onto the ends of the terminals 24, in which case the terminals 24 are commonly referred to as “wire wrap terminals.”

It is desirable to include as many pairs of terminals 24 on the terminal block 20 as space permits to increase the capacity of telephone lines that the terminal block 20, and therefore, the distribution frame 10 can accommodate. In a typical installation, the terminal block 20 accommodates up to 100 twisted pair telephone lines. A first pair of terminals 23 (FIG. 3) is required to terminate the tip wires of each telephone line and a second pair of terminals 25 (FIG. 3) is required to terminate the ring wires of each telephone line. Accordingly, the first and second pairs of terminals 23, 25 are further arranged horizontally or vertically in tip and ring pairs that correspond to a particular telephone line. As a result, a 100 pair terminal block 20 comprises a total of 400 terminals 24 consisting of 100 pair of tip terminals 23 and 100 pair of ring terminals 25. Obviously, different numbers of telephone lines and configurations of terminals are possible and are within the intended scope of the invention shown and described herein. The particular number of telephone lines and configuration of terminals shown and described is exemplary only and should not be construed as limiting the scope of the invention in any way.

It is also desirable to provide a quick connect/disconnect capability to permit a technician to rapidly process “adds, changes, and deletes” to the network wiring and to disconnect a particular telephone line for testing, for example to test the line between conditioning equipment. The need to provide a convenient location for maintenance and testing has resulted in terminal blocks that include a cross-connect field for wiring terminations and a separate connect/disconnect field for testing. However, the inclusion of separate cross-connect and connect/disconnect fields on the terminal block requires additional connections, and thus, limits the capacity of the terminal block. For example, a particular terminal block available from the Cook Electric division of Coming Cable Systems LLC and sold under the trade name Series 130-1001, requires a total of six connections per telephone line and the capacity of the terminal block is limited to about 60 telephone lines (i.e., 360 terminals). The present invention eliminates the need for separate cross-connect and connect/disconnect fields, thereby requiring only four connections per telephone line utilizing the footprint of existing terminal blocks. Accordingly, the terminal block of the invention provides a quick connect/disconnect capability while maintaining a capacity of 100 telephone lines and interchangeability with existing terminal blocks. The terminal block of the present invention also substantially reduces or eliminates the possibility that connections on the terminal block will be inadvertently disconnected, as will be explained.

The base 22 of the terminal block 20 is generally box-shaped and has length, width and depth dimensions sufficient to receive the 400 terminals 24 required to accommodate up to 100 telephone lines. As best shown in FIG. 3, the base 22 defines a generally planar front surface 26 and a generally planar rear surface 28 opposite the front surface. The base 22 also has a plurality of openings 27 formed therein. Each opening 27 is disposed between a pair of terminals 24 to define a cavity 29 therebetween. In the various embodiments described and illustrated herein, the openings 27 extend entirely through the base 22 between the front surface 26 and the rear surface 28. The openings 27 may, however, extend only partially through the base 22 inwardly from either the front surface 26 or the rear surface 28, or both. Regardless, each opening 27 receives a pair of opposed terminals 24 for connecting the tip or ring wires of a telephone line. The terminal block 20 further comprises a plurality of plugs 30. Each plug 30 is positioned within the cavity 29 defined by an opening 27 to electrically connect and disconnect a corresponding pair of terminals 24. Accordingly, a total of 200 plugs 30 are required to accommodate the 100 telephone lines in the exemplary 100 pair terminal block 20 described and illustrated herein. A single plug 30, however, may easily be configured to electrically connect and disconnect both the tip terminals 23 and the ring terminals 25 of a particular telephone line, in which case only 100 such plugs would be required to interconnect the 100 telephone lines.

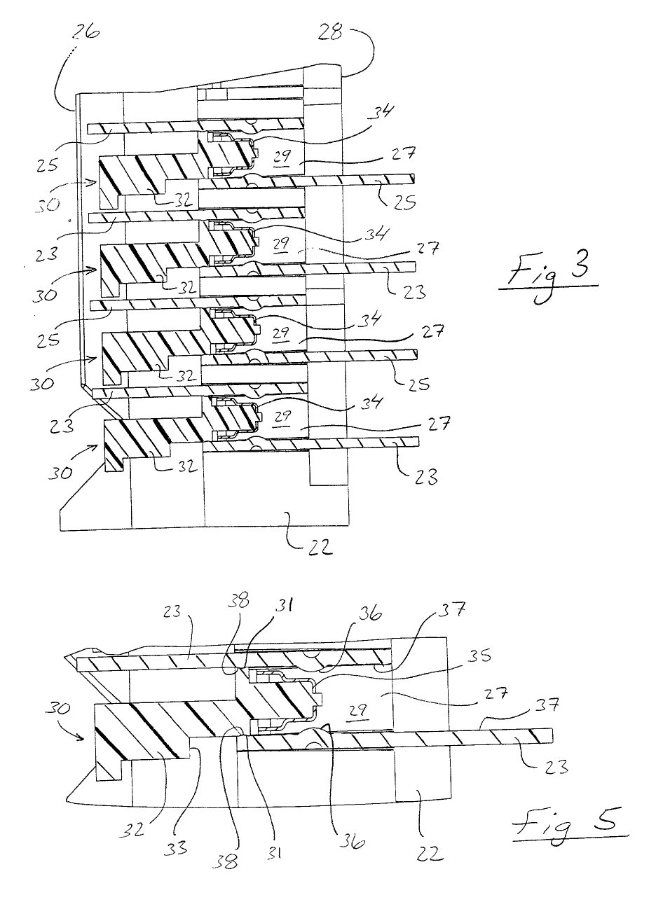

Each plug 30 comprises a body 32 made of a dielectric material and at least one conductive contact 34 attached to the body. The plug 30 is positioned within the opening 27 for reciprocal movement between a first, disconnect position wherein the terminals 24 are electrically disconnected and a second, connect position wherein the terminals 24 are electrically connected. An exemplary embodiment of the plug 30 is illustrated in the disconnect position in FIG. 5 and in the connect position in FIG. 6. In the exemplary embodiment, the plug 30 connects and disconnects the tip terminals 23 of one of the telephone lines interconnected by the terminal block 20. Although the tip terminals 23 are shown by way of example, the plug 30 connects and disconnects the ring terminals 25 of the telephone line in the same manner. Accordingly, only the construction and the operation of the plug 30 in connection with the tip terminals 23 need be shown and described. As shown, the conductive contact 34 of the plug 30 is an elastic, bell-shaped leaf spring 35 made of a conductive material, such as copper or gold, attached to the forward end of the body 32. The body 32 of the plug 30 comprises an indentation 31 that cooperates with a first detent 38 formed on the inner surface 37 of each tip terminal 23 to retain the plug in the disconnect position when the plug 30 is pulled outwardly from the terminal block 20. Alternatively, the first detent 38 may be provided on the base 22 of the terminal block 20.

When the plug 30 is pushed inwardly from the disconnect position to the connect position (FIG. 6), the leaf spring 35 engages a contact surface 36 formed on the inner surface 37 of each tip terminal 23. As shown the contact surface 36 is an inwardly facing convex surface that engages the elastic ends of the leaf spring 35 as the plug 30 is pushed into the opening 27, thereby completing an electrical connection between the pair of tip terminals 23. The indentation 31 on the body 32 of the plug 30 cooperates with a second detent 39 formed on the inner surface 37 of each tip terminal 23 to retain the plug 30 in the connect position. The second detent 39 is preferably formed adjacent the contact surface 36, but may be formed at any location on the tip terminal 23 that is suitable for cooperating with the indentation 31. Alternatively, the second detent 39 may be provided on the base 22 of the terminal block 20. A mechanical stop 33 may also be provided on the body 32 of the plug 30 for engaging the base 22 of the terminal block 20 when the plug 30 is fully inserted in the opening 27. In any event, an electrical connection is established between the tip terminals 23 when the plug 30 is fully inserted in the opening 27 of the base 22 of the terminal block 20 and is maintained as long as the plug 30 remains fully inserted and retained by the second detents 39 formed on the inner surfaces 37 of the tip terminals 23.

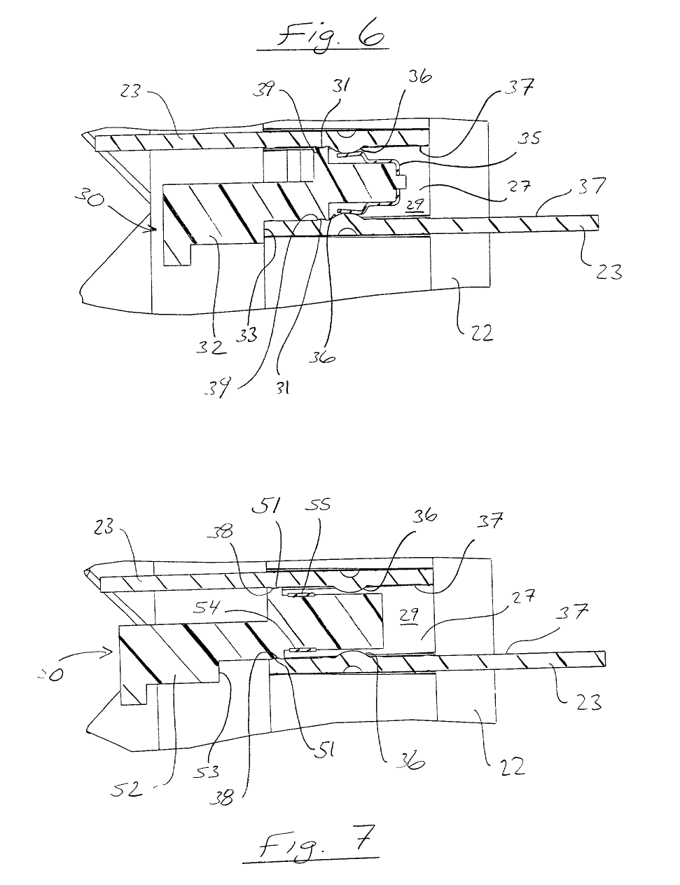

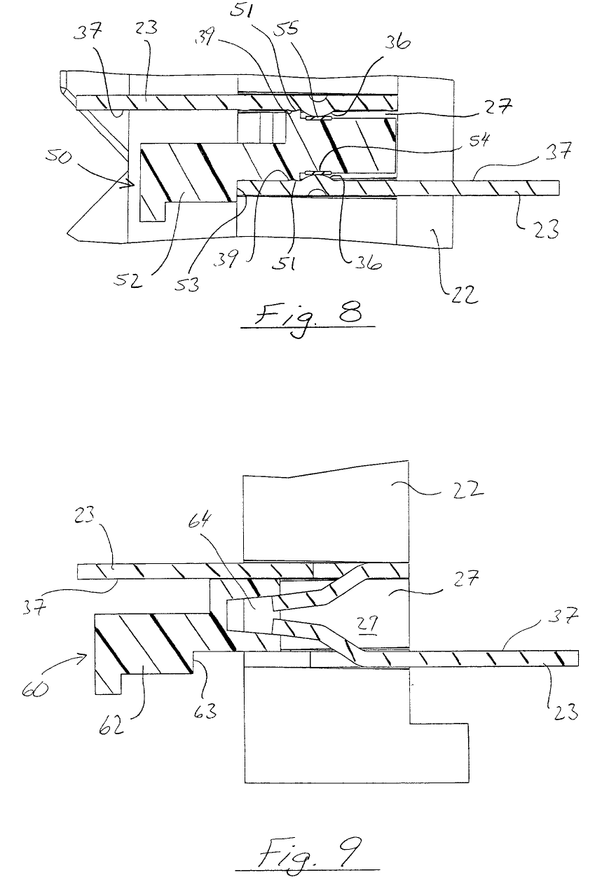

An alternative embodiment of a plug 50 constructed in accordance with the invention is shown in the disconnect position in FIG. 7 and in the connect position in FIG. 8. The plug 50 operates in the same manner as the plug 30 previously described, and thus, only the differences in the construction of the plug 50 will be described herein. In particular, the plug 50 comprises a body 52 and a conductive contact 54 that are shaped differently than the body 32 and the conductive contact 34 of the plug 30. The forward portion of the body 52 of the plug 50 is larger than the body 32 of the plug 30, thereby positioning the plug 50 more securely within the opening 27 disposed between the tip terminals 23. The conductive contact 54 comprises a sleeve 55 made of a conductive material, such as copper or gold, attached to the outer surface of the forward portion of the body 52. An indentation 51 in the body 52 cooperates with the first detent 38 formed on the inner surface 37 of each tip terminal 23 to retain the plug 50 in the disconnect position. When the plug 50 is pushed inwardly into the opening 27, the sleeve 55 engages the contact surface 36 formed on the inner surface 37 of each tip terminal 23, thereby completing an electrical connection between the pair of tip terminals 23. The indentation 51 on the body 52 of the plug 50 cooperates with the second detent 39 formed on the inner surface 37 of each tip terminal 23 to retain the plug 30 in the connect position. A mechanical stop 53 may also be provided on the body 52 of the plug 50 for engaging the base 22 of the terminal block 20 when the plug 50 is fully inserted in the opening 27.

Yet another alternative embodiment of a plug 60 constructed in accordance with the invention is shown in the disconnect position in FIG. 9 and in the connect position in FIG. 10. The plug 60 operates in a different manner and is constructed differently than the plug 30 previously described. In particular, the plug 60 comprises a body 62 that is shaped differently than the body 32 of the plug 30. Furthermore, the plug 60 does not comprise a conductive contact equivalent to the conductive contact 34 of the plug 30. The forward portion of the body 62 of the plug 60 is sized to position the plug 60 securely within the opening 27 disposed between the tip terminals 23 and defines an interior recess 64 that receives the inner ends of the tip terminals 23. The opening of the recess 64 is tapered such that the ends of the tip terminals 23 are forced together into physical contact as the plug 60 is inserted into the opening 27, thereby completing an electrical connection between the pair of tip terminals 23. As previously described, an indentation in the body 62 may be provided to cooperate with first and second detents formed on the inner surface 37 of each tip terminal 23 to retain the plug 50 in the disconnect position and the connect position, respectively. Alternatively, the forward portion of the body 62 may frictionally engage the inner surfaces 37 of the tip terminals 23 to retain the plug 60 in the disconnect position and the connect position. A mechanical stop 63 may also be provided on the body 62 of the plug 60 for engaging the base 22 of the terminal block 20 when the plug 60 is fully inserted in the opening 27.

A feature of the terminal block shown and described herein is that the pairs of terminals (i.e., tip terminals 23 and ring terminals 25) are disconnected when the plug is pulled out and are connected when the plug is pushed in. Accordingly, the terminal block can be manufactured, assembled, and shipped with the pairs of terminals pre-connected. As a result, the telephone lines will be automatically interconnected when the wire terminations are made. Furthermore, the possibility that connections on the terminal block will be inadvertently disconnected is substantially reduced or eliminated. Specifically, if a technician inadvertently applies an axial force to a plug when leaning against the distribution frame or when working on another portion of the terminal block, the plug will remain in the connect position with the corresponding terminals electrically connected. Yet another feature of the invention is that the terminal block provides a quick connect/disconnect capability in the cross-connect field while utilizing the same footprint as existing terminal blocks. Thus, the capacity of existing terminal blocks is maintained or increased, thereby reducing the cost to manufacture and configure the terminal block and reducing the potential for connection errors and subsequent failures. Still another feature of the invention is that the terminal block does not utilize a separate insert to interrupt the electrical connection between the terminals. Thus, the likelihood that the insert will be misplaced or lost is eliminated.

While the invention has been shown and described in various embodiments, it should be apparent to those skilled in the art that it is not so limited, but is susceptible to various changes without departing from the scope of invention. Accordingly, it is intended that the appended claims encompass any alternative embodiments of the invention not disclosed herein that are within the ordinary skill of a person knowledgeable in the art of terminal blocks of the type used in a telecommunications network for wire management and to accomplish cross-connect and switch termination functions.

That which is claimed is:

1. A terminal block comprising:
a base;
at least one pair of conductive terminals depending outwardly from the base;
at least one opening formed in the base and disposed between the pair of terminals; and
a plug positioned within the opening formed in the base for reciprocal movement between a first position wherein the pair of terminals are electrically disconnected and a second position wherein the pair of terminals are electrically connected.

2. A terminal block according to claim 1, wherein the plug is made of a dielectric material.

3. A terminal block according to claim 2, wherein the plug comprises a body and a conductive contact attached to the body and wherein the conductive contact engages the pair of terminals in the second position to complete an electrical circuit therebetween.

4. A terminal block according to claim 3, wherein the body of the plug has a forward end that is inserted into the opening formed in the base and the conductive contact comprises a leaf spring attached to the forward end of the body.

5. A terminal block according to claim 3, wherein the body of the plug has a forward end that is inserted into the opening formed in the base and the conductive contact comprises a sleeve attached to the forward end of the body.

6. A terminal block according to claim 2, wherein the body of the plug has a forward end that is inserted into the opening formed in the base, the forward end defining a recess that receives the pair of terminals therein and forces the pair of terminals together to complete an electrical circuit therebetween in the second position.

7. A terminal block according to claim 1, wherein the plug is retained within the opening formed in the base in both the first position and the second position.

8. A terminal block according to claim 7, wherein the body has an indentation and wherein each of the pair of terminals has a first detent for retaining the plug in the first position.

9. A terminal block according to claim 7, wherein the body has an indentation and wherein each of the pair of terminals has a second detent for retaining the plug in the second position.

10. A terminal block according to claim 1, wherein the base defines a front surface and a rear surface opposite the front surface and wherein one of the pair of terminals depends outwardly from the front surface and the other of the pair of terminals depends outwardly from the rear surface.

11. A terminal block for mounting on a distribution frame in a telecommunications network, the terminal block comprising:
a base defining a front surface and a rear surface separated from and opposite the front surface;
at least one pair of conductive terminals depending outwardly from the base;
at least one opening formed in the base and disposed between the pair of terminals; and
a plug made of a dielectric material and positioned within the opening formed in the base such that the pair of terminals are electrically connected when the plug is inserted into the opening.

12. A terminal block according to claim 11, wherein the plug comprises a body and a conductive contact attached to the body and wherein the conductive contact engages the pair of terminals when the plug is inserted into the opening.

13. A terminal block according to claim 12, wherein the body of the plug has a forward end that is inserted into the opening formed in the base and the conductive contact comprises a leaf spring attached to the forward end of the body.

14. A terminal block according to claim 12, wherein the body of the plug has a forward end that is inserted into the opening formed in the base and the conductive contact comprises a sleeve attached to the forward end of the body.

15. A terminal block according to claim 11, wherein the body of the plug has a forward end that is inserted into the opening formed in the base, the forward end defining a recess that receives the pair of terminals therein and forces the pair of terminals together to complete an electrical circuit therebetween when the plug is inserted into the opening.

16. A terminal block according to claim 11, wherein the plug is retained within the opening formed in the base.

17. A terminal block according to claim 16, wherein the body has an indentation and wherein each of the pair of terminals has a first detent for retaining the plug within the opening formed in the base.

18. A terminal block according to claim 16, wherein the body has an indentation and wherein each of the pair of terminals has a second detent for retaining the plug within the opening formed in the base.

19. A terminal block according to claim 11, wherein one of the pair of terminals depends outwardly from the front surface and the other of the pair of terminals depends outwardly from the rear surface.

20. A terminal block for mounting on a distribution frame in a telecommunications network, the terminal block comprising:
a base having a length dimension, a width dimension and a depth dimension, the depth dimension being less than the length dimension and the width dimension, the base defining a generally planar front surface and a generally planar rear surface opposite the front surface, the front surface and the rear surface separated by the depth dimension;
at least one pair of conductive wire wrap terminals depending outwardly from the base;
at least one opening formed in the base and disposed between the pair of wire wrap terminals; and
a plug made of a dielectric material and positioned within the opening formed in the base for reciprocal movement between a disconnect position wherein the pair of wire wrap terminals are electrically disconnected and a connect position wherein the pair of wire wrap terminals are electrically connected.

21. A distribution frame for interconnecting telephone lines in a telecommunications network, the distribution frame comprising:
at least one terminal block mounted on the frame, the terminal block comprising a base;
at least one pair of conductive terminals depending outwardly from the base;
at least one opening formed in the base and disposed between the pair of terminals; and
a plug mounted within the opening formed in the base for reciprocal movement between a first position wherein the pair of terminals are electrically disconnected and a second position wherein the pair of terminals are electrically connected.

22. A terminal block according to claim 21, wherein the plug is made of a dielectric material.

23. A terminal block according to claim 22, wherein the plug comprises a body and a conductive contact attached to the body and wherein the conductive contact engages the pair of terminals in the second position to complete an electrical circuit therebetween.

24. A terminal block according to claim 23, wherein the body of the plug has a forward end that is inserted into the opening formed in the base and the conductive contact comprises a leaf spring attached to the forward end of the body.

25. A terminal block according to claim 23, wherein the body of the plug has a forward end that is inserted into the opening formed in the base and the conductive contact comprises a sleeve attached to the forward end of the body.

26. A terminal block according to claim 22, wherein the body of the plug has a forward end that is inserted into the opening formed in the base, the forward end defining a recess that receives the pair of terminals therein and forces the pair of terminals together to complete an electrical circuit therebetween in the second position.

27. A terminal block according to claim 21, wherein the plug is retained within the opening formed in the base in both the first position and the second position.

28. A terminal block according to claim 27, wherein the body has an indentation and wherein each of the pair of terminals has a first detent for retaining the plug in the first position.

29. A terminal block according to claim 27, wherein the body has an indentation and wherein each of the pair of terminals has a second detent for retaining the plug in the second position.

30. A terminal block according to claim 21, wherein the base defines a front surface and a rear surface opposite the front surface and wherein one of the pair of terminals depends outwardly from the front surface and the other of the pair of terminals depends outwardly from the rear surface.
